(19) United States
(12) Patent Application Publication
(10) Pub. No.: US 2004/0175298 A1
(43) Pub. Date: Sep. 9, 2004

(54) Microfluidic system

(76) Inventor: Konstanin Choikhet, Kou lstuche (DE)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/778,537

(22) Filed: Feb. 17, 2004

(30) Foreign Application Priority Data
Feb. 15, 2003 (EP) 03003509.1

(51) Int. Cl. B01L 3/02

(52) U.S. Cl. 422/100; 422/104

(57) ABSTRACT

The invention refers to a microfluidic system, particularly a microfluidic chip with at least one analytical channel in which a fluid and/or constituents contained therein are movable, and with a detection area in which the fluid and/or the constituents contained therein can be analyzed. At least three channel sections of said channel or of channels cross a substantially linear scan area within the detection area, wherein at least one of the channels has a meander-shaped channel section within the detection area, so that at least two of its channel sections cross the scan area.

### FIELD OF INVENTION

The invention relates to a microfluidic system, particularly a microfluidic chip, with at least one analytical channel in which a fluid and/or constituents contained therein are movable by a driving force, particularly by using of pressure, acoustic energy and/or an electrical field, through the analytical channel, and with a detection area in which the fluid and/or the constituents contained in the analytical channel can be detected and/or analyzed.

### BACKGROUND ART

In analytical systems based on a microfluidic chip platform and using optical (UV, fluorescent etc.) detection it is necessary to correctly position the chip relatively to the optical system, i. e. so that the measuring optical system is focused at the chip structures relevant for detection. For that purpose, an automated procedure is desirable, and it is especially necessary for highly automated instruments using disposable or exchangeable microfluidic chips.

Usually these kind of instruments are capable of scanning the microfluidic chip in direction across the lanes, i. e. across the capillary channel structures, in which the detection is to be performed, and are capable of aligning the microfluidic chip to the optical system in terms of the distance between the focus point and the plane of the microfluidic chip, e. g. by aligning the chip to the optical system along the optical axis by moving the chip in a direction perpendicular to the plane of the chip. This method is especially applied by using a confocal fluorescence detector. A direct search for the chip position, at which the highest response signal is obtained, is the most direct and thus most reliable procedure for chip alignment.

One of the problems to be solved during the search for this optimum position is to distinguish between the relevant structures on the chip and possible artifacts. In order to achieve this, it is less reliable to refer to any absolute positioning parameters when aligning the chip or in an attempt to distinguish the chip structures from the artifacts; the more reliable approach is to recognize a certain pattern of relevant structures on a chip and then to bring it in focus. It is readily realizable in the case of microfluidic chips with multiple lanes, i. e. three or more lanes, at which the detection is to be performed. In this case, a pattern of signals corresponding to the number of lanes can be defined for a scan across the chip and thus the signals corresponding to the lanes can be reliably distinguished from those of artifacts.

In the case of microfluidic chips having a less number of lanes, i. e. only one or two lanes, no recognizable pattern can be defined based on the relative position of the lanes. In the case of only one single lane, there are no geometric criteria at all to distinguish a signal of the lane from that of an eventual artifact. Neither it is possible to distinguish two lane signals in the presence of an eventual artifact on the microfluidic chip with only two lanes, unless an absolute distance between the two lanes is measured, which in turn can be instrument-dependent and thus, is less reliable. The use of microfluidic chips having low number of lanes (one or two) interspersing the detection area is a need in applications with low to medium sample throughput. Low number of lanes (e.g. two) is also a need for applications including complex on-chip procedures and thus requiring a complex channel matrix design with numerous reagent and/or sample wells, as e.g. protein analyses or the like.

### SUMMARY OF INVENTION

One aspect of the invention concerns a microfluidic chip for a microfluidic system, wherein the microfluidic chip has (a) at least one microfluidic channel in which a fluid is movable by a driving force, and (b) a detection area where a portion of the at least one microfluidic channel is located. The detection area is arranged for detection of the fluid and/or a constituent of the fluid in the at least one microfluidic channel. The portion of the at least one microfluidic channel in the detection area includes a meandering segment having plural sections that can be crossed by a substantially linear scan area within the detection area. The scan area for a single channel enables (a) a determination to be made of the position of the single channel and (b) a detection point of the single channel to be set. The scan area for plural channels enables (a) a determination to be made of the position of the plural channels and (b) the detection points of each of the plural channels to be set.

In one embodiment, the detection area includes plural microfluidic channels adapted to be crossed by the substantially linear scan area. One of the plural microfluidic channels has a meandering segment arranged to be crossed at least twice by the substantially linear scan area.

In another embodiment, the detection area includes plural microfluidic channels each having a meandering segment adapted to be crossed by the substantially linear scan area. The meandering segment of each of the plural microfluidic channels is adapted to be crossed by the substantially linear scan area at least twice.

In a further embodiment, the detection area includes a microfluidic channel having a meandering segment adapted to be crossed by the substantially linear scan area three times.

In an additional embodiment, the detection area includes (a) a first microfluidic channel having a meandering segment adapted to be crossed by the substantially linear scan area at least three times and (b) a second microfluidic channel having a meandering segment adapted to be crossed by the linear scan area at least twice.

In yet a further embodiment aspect of the invention, the microchip is in combination with a microfluidic system that responds to energy propagating from crossing points between the linear scan area and the channel(s) to continue the position of the microchip in a direction perpendicular to a planar surface of the microchip.

The microfluidic chip can be arranged so the at least one microfluidic channel includes a non-analyte material from which energy is adapted to propagate at a crossing point between the at least one microfluidic channel and the substantially linear scan area.

Alternatively, the microfluid a chip is arranged so the at least one microfluidic channel is adapted to include an analyte material from which energy is adapted to propagate at a first crossing point between the at least one microfluidic channel and the substantially linear scan area. The first crossing point is preferably the first crossing point in the direction of flow of the analyte material in the meandering segment of the at least one microfluidic channel.

Preferably, the three channel sections are equi-spaced from each other. Alternatively, there is a predetermined ratio between the spacings of the three channel sections.

A further aspect of the invention relates to a microfluidic chip including a supply area, a detection area and at least one microfluidic channel arranged so material can be moved through the at least one channel from the supply area to the detection area. The at least one channel has a meandering segment in the detection area. The meandering segment of the at least one channel in the detection area is arranged so the meandering segment in the detection area is crossed by a straight line twice.

In one embodiment, one of the channels included in the meandering segment has first, second and third mutually parallel straight longitudinally extending portions each of which is crossed once by the straight line. The spacing between the first and second portions preferably equals the spacing between the second and third portions. Alternatively, the spacing between the first and second portions has a predetermined ratio to spacing between the second and third portions.

In a second embodiment, two of the channels have meandering segments in the detection area. The two channels having the meandering segments in the detection area are preferably arranged so that the meandering segments in the detection area of the two channels are crossed by the straight line at least three times. The two channels having the meandering segments in the detection area are preferably arranged so that the meandering segment in the detection area of a first of the two channels is crossed by the straight line at least twice and the meandering segment in the detection area of a second of the two channels is crossed by the straight line at least twice. Preferably, (1) the first of the two channels includes first and second mutually parallel straight longitudinally extending portions, each of which is crossed once by the straight line, (2) the second of the two channels includes third and fourth mutually parallel straight longitudinally extending portions that are parallel to the first and second longitudinally extending portions, and (3) each of the third and fourth longitudinally extending portions is crossed once by the straight line.

In a preferred embodiment, the spacing between the first and second longitudinally extending portions equals the spacing between the second and third longitudinally extending portions, and the spacing between the third and fourth longitudinally extending portions equals the spacing between the second and third longitudinally extending portions. In another embodiment, there is a predetermined ratio in the spacing between the first and second longitudinally extending portions relative to the spacing between the second and third longitudinally extending portions and between the third and fourth longitudinally extending portions.

Usually, the microfluidic chip includes a substantially planar portion and is included in a microfluidic system including a controller for the position of the microchip in a direction perpendicular to the substantially planar portion of the microfluidic chip. The controller preferably responds to energy propagating from at least three of the crossing points of the straight line and the meandering segment in the detection area.

The microfluidic channel(s) is arranged so material flows in a predetermined direction in the channel(s) through the detection area. The microfluidic system includes a detector for a characteristic of the material in the channel. The detector for the characteristic of the material in the channel is preferably arranged to be responsive to the material in the channel at the initial crossing point of the straight line and the channel in the direction of flow of material in the channel through the detection area.

In the embodiment wherein one microfluidic channel is included in the meandering segment, the one microfluidic channel included in the meandering segment is arranged so material flows in a predetermined direction in the one microfluid channel through the detection area. The microfluidic system includes a detector for a characteristic of the material in the one channel. The detector for the characteristic of the material in the channel is preferably arranged to be responsive to the material in the channel at the initial crossing point of the straight line and the one channel in the direction of flow of material in the one channel through the detection area.

In the embodiment wherein first and second microfluidic channels are included in the meandering segment, the first and second microfluidic channels included in the meandering segment are arranged so material flows in a predetermined direction in the first microfluidic channel through the detection area and material flows in a predetermined direction in the second microfluidic channel through the detection area. The microfluidic system includes first and second detectors for characteristics of the materials in the first and second channels, respectively. The first detector for the characteristic of the material in the first channel is preferably arranged to be responsive to the material in the first channel at the initial crossing point of the straight line and the first channel in the direction of flow of the material in the first channel through the detection area. The second detector for the characteristic of the material in the second channel is preferably arranged to be responsive to the material in the second channel at the initial crossing point of the straight line and the second channel in the direction of flow of the material in the second channel through the detection area.

The above and still further objects, features and advantages of the present invention will become apparent upon consideration of the following detailed descriptions of several specific embodiments thereof, especially when taken in conjunction with the accompanying drawings.

### BRIEF DESCRIPTION OF THE DRAWING

The figures show:

FIG. 1 a three-dimensional view of a microfluidic chip containing a number of reservoirs to receive fluid substances and containing an open network of interconnected micro-channels, wherein one or more separation channels serving as operational or analytical channels are provided, which may especially be used in electrically driven (electrophoretic) fluid analysis, and which intersperses a transparent detection area, so that an optical analysis is possible, e. g. by way of a confocal fluorescence detector (not shown);

FIG. 2 an enlarged top view of the detection area of FIG. 1 in a first embodiment, showing one single analytical channel which is meander-shaped, wherein three meanders crossing a linear straight scan area;

FIG. 3 an enlarged top view of the detection area of FIG. 1 in a second embodiment, showing two analytical channels, which are both meander-shaped, wherein two meanders of each main channel are crossing a linear straight scan area.

### DETAILED DESCRIPTION OF THE DRAWING

The microfluidic system 20 contains a microfluidic chip 21. It includes the caddy 22 serving as a housing that contains here a total of twenty-four reservoirs, which are also called wells to receive diverse fluidic substances. The reservoirs 23 may receive a buffer that serves as a separating medium and other of them may be pre-filled with some buffer solution, or standards, or samples, or be used to receive waste. Some of the reservoirs 23 are mutually fluid connected via micro-channels that jointly form one or several open fluidic networks within the chip. Also the microfluidic chip 21 can include capillaries (sippers) at its bottom side (not shown in the drawings), which are used for transporting samples e.g. by sucking or drawing (sipping) into the microfluidic chip 21 for further analysis.

The microfluidic chip 21 contains a transparent detection area 24, which is interspersed by one analytical channel 25 (FIG. 2) or by two or more analytical channels 41, 42 (FIG. 3). It is understood that in case of two or more channels interspersing the detection area 24 that one or more of these interspersing channels must not be analytical or separating channels but also can be channels which do not serve as analytical channels but which also may serve as means to provide a desired channel pattern.

In the embodiment as shown in FIG. 2 one single capillary analytical channel 25 contains a meander-shaped section 32, i.e. the analytical channel 25 has several meanders 37. Due to that, the analytical channel 25 contains three channel sections 28, 29, 30 which are preferably arranged parallel to each other, wherein channel sections 28 and 29 and channel sections 29 and 30 are each fluid connected by further channel sections, which are in this embodiment curved segments, but can also be straight lines. Thus, a S-shaped meander structure is achieved.

Each of the channel sections 28, 29, 30 crosses a linear and straight scan area 27. This scan area 27 serves to perform a cross-scan for developing the optimal position of the microfluidic chip relative to an optical sensor (not shown) with respect to a maximization of a response signal or maximization of signal to noise ratio of the detector.

As can clearly be seen, channel sections 28, 29, 30 each cross the scan area 27 at scannable points 34, 35, 36 respectively, so that channel sections 28, 29 and channel sections 29, 30 next to each other are arranged within the scan area 27 in essentially the same distance 38, 39 in this embodiment.

In the embodiment shown in FIG. 2 the analytical channel 25 and all its channel sections, including the channel sections 28, 29, 30 are arranged within a flat plane, which corresponds to the horizontal plane of the microfluidic chip 21.

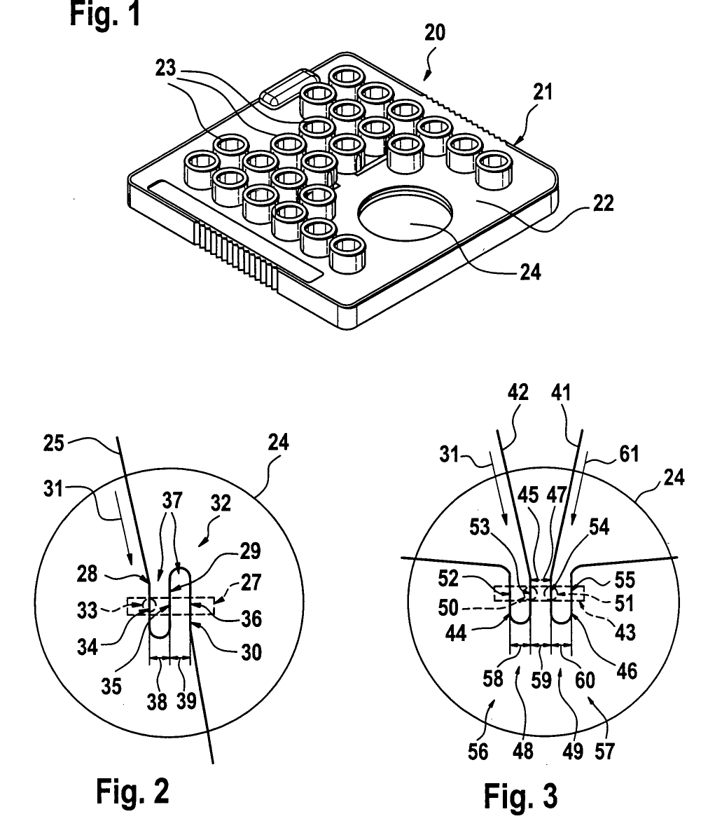

As can further be seen from FIG. 1 within the scan area 27 a detection place or point 33 is provided. This detection point 33 is set at the channel section 28 of the channel 25 which is located upstream in relation to the direction of flow 31 or sample migration respectively, of a fluid in channel 25.

In the embodiment as shown in FIG. 3, two analytical channels 41, 42 are provided for in a detection area 24. Each channel 41, 42 contains a meander-shaped section 48 and 49. I. e. channel 41 has several meanders 56 and channel 42 has several meanders 57. The meanders 56, 57 of these channels 41, 42 cross the scan area 43 at least two times, each with their channel sections 44 and 45 as well as 46 and 47. Channel sections 44, 45 and 46, 47 are arranged parallel to each other in this embodiment.

Thus, in this embodiment, the linear straight lane scan area 43 is crossed at four scannable points 52, 53, 54, 55 in a way that each of the two channels 41, 42 cross the scan area 43 two times.

Channel sections 44 and 45 as well as channels sections 46, and 47 are both fluid connected by a further channel section of channels 41 or 42 respectively, which are in this embodiment curved segments, but can also be straight lines. Channel section 44 and channel section 45 next to it is arranged in a distance 58. Channel section 46 and channel section 47 next to it is arranged in a distance 60, which in this embodiment is essentially equal to distance 58. Further on, channel section 45 and channel section 47 next to it is arranged in a distance 59 that in this embodiment is essentially equal to distances 58 and 60.

As can be seen from FIG. 3, two detection points 50, 51 are set within the scan area 43. Detection point 50 is set at channel section 45 of channel 41 whereas detection place 51 is set at channel section 47 of channel 42. These channel sections 45 and 47, and thus the detection points 50 and 51, are located upstream in relation to the direction of flow 31, 61 or migration respectively of the fluid and/or constituents therein, in channels 41 and 42 respectively.

Channels 41 and 42 and all of their channel sections, including channel sections 44, 45, 46, 47 are arranged in this embodiment within a flat plane corresponding to a horizontal plane of the microfluidic chip 21.

In a further important embodiment, the invention refers to a microfluidic system, particularly a microfluidic chip 21 with at least one analytical channel 25 in which a fluid and/or constituents contained therein are movable, and with a detection area 24 in which the fluid and/or the constituents contained therein can be detected and/or analyzed. At least three channel sections 28, 29, 30; 44, 45, 46, 47 of said channel 25 or of channels 41, 42 cross a scan area 27, 43 within the detection area 24, which scan area is preferably designed substantially linear, wherein at least one of the channels 25; 41, 42 has a meander-shaped channel section 32, so that at least two of its channel sections 28, 29, 30 cross the scan area 27.

1. A microfluidic chip for a microfluidic system, the microfluidic chip having (a) at least one microfluidic channel in which a fluid is movable by a driving force, and (b) a detection area where a portion of the at least one microfluidic channel is located, the detection area being arranged for detection of at least one of (i) the fluid and (ii) a constituent of the fluid in the at least one microfluidic channel, the portion of the at least one microfluidic channel in the detection area including a meandering segment having at plural channel sections that can be crossed by a substantially linear scan area within the detection area, said scan area for a single channel enabling (a) a determination to be made of the position of said single channel and (b) a detection point of said single channel to be set, said scan area for plural channels enabling (a) a determination to be made of the position of said plural channels and (b) the detection points of each of said plural channels to be set.

2. The microfluidic chip of claim 1 wherein the detection area includes plural microfluidic channels adapted to be crossed by the substantially linear scan area, one of the plural microfluidic channels adapted to be crossed by the substantially linear scan area having a meandering segment arranged to be crossed at least twice by the substantially linear scan area.

3. The microfluidic chip of claim 1 wherein the detection area includes plural microfluidic channels each having a meandering segment adapted to be crossed by the substantially linear scan area, the meandering segment of each of the plural microfluidic channels being adapted to be crossed by the substantially linear scan area at least twice.

4. The microfluidic chip of claim 1 wherein the detection area includes a microfluidic channel having a meandering segment adapted to be crossed by the substantially linear scan area three times.

5. The microfluidic chip of claim 1 wherein the detection area includes a first microfluidic channel having a meandering segment adapted to be crossed by the substantially linear scan area at least three times and a second microfluidic channel having a meandering segment adapted to be crossed by the linear scan area at least twice.

6. The microfluidic chip of claim 1 in combination with a microfluidic system arranged to respond to energy propagating from crossing points between the scan area and the at least one channel for controlling the position of the microfluidic system in a direction perpendicular to a planar surface of the detection area.

7. The microfluidic chip of claim 1 wherein the at least one microfluidic channel is adapted to include a non-analyte material from which energy is adapted to propagate at a crossing point between said at least one microfluidic channel and the substantially linear scan area.

8. The microfluidic chip of claim 1 wherein the at least one microfluidic channel is adapted to include an analyte material from which energy is adapted to propagate at a first crossing point between said at least one microfluidic channel and the substantially linear scan area, the first crossing point being the first crossing point in the direction of flow of the analyte material in the meandering segment of said at least one microfluidic channel.

9. The microfluidic chip of claim 1 wherein the three channel sections are equi-spaced from each other.

10. The microfluidic chip of claim 1 wherein there is a predetermined ratio between the spacings of the three channel sections.

11. A microfluidic chip including a supply area, a detection area and at least one microfluidic channel arranged so material can be moved through the at least one channel from the supply area to the detection area, the at least one channel having a meandering segment in the detection area, the meandering segment of the at least one channel in the detection area being arranged so the meandering segment in the detection area is crossed by a straight line at least twice.

12. The microfluidic chip of claim 11 wherein the meandering segment of one of the channels includes first, second and third mutually parallel straight longitudinally extending portions each of which is crossed once by the straight line.

13. The microfluidic chip of claim 12 wherein the spacing between the first and second portions equals the spacing between the second and third portions.

14. The microfluidic chip of claim 12 wherein the spacing between the first and second portions has a predetermined ratio to spacing between the second and third portions.

15. The microfluidic chip of claim 11 wherein two of the channels have meandering segments in the detection area, one of the two channels being arranged so that the meandering segment thereof is crossed by the straight line three times, the other of the two channels being arranged so that the meandering segment thereof is crossed by the straight line twice.

16. The microfluidic chip of claim 11 wherein two of the channels have meandering segments in the detection area, the two channels having the meandering segments in the detection area being arranged so that the meandering segments in the detection area of the two channels are crossed by the straight line at least three times.

17. The microfluidic chip of claim 16 wherein the two channels having the meandering segments in the detection area are arranged so that the meandering segment in the detection area of a first of the two channels is crossed by the straight line at least twice and the meandering segment in the detection area of a second of the two channels is crossed by the straight line at least twice.

18. The microfluidic chip of claim 17 wherein the first of the two channels includes first and second mutually parallel straight longitudinally extending portions, each of which is crossed once by the straight line, and the second of the two channels includes third and fourth mutually parallel straight longitudinally extending portions that are parallel to the first and second longitudinally extending portions, each of the third and fourth longitudinally extending portions being crossed once by the straight line.

19. The microfluidic chip of claim 18 wherein the spacing between the first and second longitudinally extending portions equals the spacing between the second and third longitudinally extending portions, and the spacing between the third and fourth longitudinally extending portions equals the spacing between the second and third longitudinally extending portions.

20. The microfluidic chip of claim 18 wherein there is a predetermined ratio in the spacing between the first and second longitudinally extending portions relative to the spacing between the second and third longitudinally extending portions and between the third and fourth longitudinally extending portions.

21. The microfluidic chip of claim 11 wherein the meandering segment includes first, second and third mutually parallel straight longitudinally extending portions each of which is crossed once by the straight line.

22. The microfluidic chip of claim 21 wherein the spacing between the first and second portions equals the spacing between the second and third portions.

23. The microfluidic chip of claim 11 wherein the meandering segment includes first, second, third and fourth mutually parallel straight longitudinally extending portions each of which is crossed once by the straight line.

24. The microfluidic chip of claim 23 wherein the spacing between the first and second portions equals the spacing between the second and third portions, and the spacing between the second and third portions equals the spacing between the third and fourth portions.

25. A microfluidic system including the microfluidic chip of claim 11, wherein the microfluidic chip includes a substantially planar portion, the microfluidic system including a controller for the position of the microchip in a direction perpendicular to the substantially planar portion of the microfluidic chip in response to energy propagating from points on the chip at three crossing points of the straight line and the meandering segment in the detection area.

26. The microfluidic system of claim 25 wherein the at least one microfluidic channel is arranged so material flows in a predetermined direction in the channel through the detection area, the microfluidic system including a detector for a characteristic of the material in the channel, the detector for the characteristic of the material in the channel being arranged to be responsive to the material in the channel at the initial crossing point of the straight line and the channel in the direction of flow of material in the channel through the detection area.

27. The microfluidic system of claim 25 wherein one microfluidic channel included in the meandering segment is arranged so material flows in a predetermined direction in the one microfluidic channel through the detection area, the microfluidic system including a detector for a characteristic of the material in the one channel, the detector for the characteristic of the material in the one channel being arranged to be responsive to the material in the one channel at the initial crossing point of the straight line and the one channel in the direction of flow of material in the one channel through the detection area.

28. The microfluidic system of claim 25 wherein first and second microfluidic channels are included in the meandering segment, the first and second microfluidic channels being arranged so material flows in a predetermined direction in the first microfluidic channel through the detection area and material flows in a predetermined direction in the second microfluidic channel through the detection area, the microfluidic system including first and second detectors for characteristics of the materials in the first and second channels, respectively, the first detector for the characteristic of the material in the first channel being arranged to be responsive to the material in the first channel at the initial crossing point of the straight line and the first channel in the direction of flow of the material in the first channel through the detection area, the second detector for the characteristic of the material in the second channel being arranged to be responsive to the material in the second channel at the initial crossing point of the straight line and the second channel in the direction of flow of the material in the second channel through the detection area.
